(19) United States
(12) Patent Application Publication
(10) Pub. No.: US 2022/0190651 A1
(43) Pub. Date: Jun. 16, 2022

(54) COMMUNICATION WITH WIRELESS POWER TRANSMITTER

(71) Applicant: POWERMAT TECHNOLOGIES LTD., Petach Tikva (IL)

(72) Inventor: Itay SHERMAN, Hod-Hasharon (IL)

(73) Assignee: POWERMAT TECHNOLOGIES LTD., Petach Tikva (IL)

(21) Appl. No.: 17/440,823

(22) PCT Filed: Mar. 20, 2020
(86) PCT No.: PCT/IB2020/052597

§ 371 Date: Sep. 20, 2021

Related U.S. Application Data
(60) Provisional application No. 62/820,899, filed on Mar. 20, 2019.

(51) Int. Cl. H02J 50/80; H02J 7/00; H02J 50/12; H02J 50/90; H04B 5/00

(52) U.S. Cl. CPC H02J 50/80; H02J 7/00034; H02J 50/12; H04L 43/10; H04B 5/0037; H04B 5/0081; H02J 50/90

(57) ABSTRACT

According to one aspect of the present disclosed subject matter, a communication method for the wireless power charging system, having a device comprising a speaker configured to play audio-coded data-file, the method comprising: detecting, by a controller of a transmitter, voltage or current fluctuations in a coil of the transmitter; executing an audio-coded data-file reception-sequence; determining if the device comprising a power receiver; activating wireless power transmission to the device; and wherein the fluctuations correspond to audio-tones composing the audio-coded data-file played by the speaker, and wherein the reception-sequence decode and process the audio-tones for assembling the data-file.

### CROSS-REFERENCE TO RELATED APPLICATION

This application claims priority under 35 U.S.C. § 119(e) from co-pending; U.S. Provisional Patent Application No. 62/820899, by Itay Sherman, titled “OTA of inductive charging spot using sound”, filed on Mar. 20 2019, which is incorporated in its entirety by reference for all purposes.

### TECHNICAL FIELD

The present disclosed subject matter relates to communication between a wireless power transmitter and a device. More particularly, the present disclosed subject matter relates to a system and method for wireless power transmitters designed for receiving audio coded data files generated by devices having a speaker.

### BACKGROUND

Growing demand for wireless power charging systems, led to dramatic deployments increase, in a wide variety of venues, raises the need for facilitating communication between units, such as a transmitter and a receiver of a wireless power system.

Commercially available inductive charging transmitters include a coil coupled to a capacitor to form a resonant circuit that creates a magnetic flux when AC current is transferred through it. Typically, the charging transmitter drives AC voltage through the resonant circuit creating the necessary AC current.

The charging transmitter thus generates a time-varying electromagnetic field, which transmits power across space to a receiver device, which extracts power from the electromagnetic field and supplies it to an electrical load.

The inductive charging transmitter also includes the capability of communicating with a chargeable device (receiver) based on protocols that comply with communications standards, such as power matters alliance (PMA); wireless power Consortium (WPC) and AirFuel Alliance.

### BRIEF SUMMARY

According to one aspect of the present disclosed subject matter, a communication method for the wireless power charging system, having a device comprising a speaker configured to play audio-coded data-file, the method comprising: detecting, by a controller of a transmitter, voltage or current fluctuations in a coil of the transmitter; executing an audio-coded data-file reception-sequence; determining if the device comprising a power receiver; activating wireless power transmission to the device; and wherein the fluctuations correspond to audio-tones composing the audio-coded data-file played by the speaker, and wherein the reception-sequence decode and process the audio-tones for assembling the data-file.

In some exemplary embodiments, the detecting comprising decoding fluctuations corresponding to a plurality of different audio-tones generated by the device for encoding information of the data-file, and wherein the fluctuations in the coil results from external magnetic fields caused by audio-tones played by speaker.

In some exemplary embodiments, the detecting is conducted during a first-time-period of a monitoring-sequence, wherein the transmitter is set to either tri-state or short-state in the first-time-period.

In some exemplary embodiments, the first-time-period is at least two times longer than a time period of any audio-tone of the audio-tones.

In some exemplary embodiments, the audio-tones comprising sixteen different tones, and wherein each tone of the sixteen different tones corresponding to four bits of data.

In some exemplary embodiments, the executing comprising identifying a sync pattern preceding the data-file, wherein the sync pattern is composed of a string of audio-tones selected from the group consisting of first-tones; and second-tones.

In some exemplary embodiments, the executing comprising converting the audio-tones to binary bits, wherein the audio-tones are selected from the group consisting of third-tones; and fourth-tones, wherein of the third-tones are converted to ones and fourth-tones are converted to zeros, and wherein the executing further comprising processing the bits to packets and extracting a plurality of error correction bytes from each packet.

In some exemplary embodiments, the executing comprising utilizing the plurality of error correction bytes for executing error correction for each packet.

In some exemplary embodiments, the executing comprising extracting from each packet a preamble indicating a beginning of the packet and extracting a value defining a length of the data-file and a checksum value of the file from a first packet of the data-file.

In some exemplary embodiments, the executing further comprising indicating a communication error to the device that results from either a failure of the executing error correction or a failure determined based on calculating the checksum value.

In some exemplary embodiments, the executing comprising determining a last packet and assembling the packets into a date file and storing the file in a memory of the controller.

In some exemplary embodiments, the determining if the device comprising a power receiver further comprising determining if the device comprising a power receiver is placed on the transmitter by sending a ping from the transmitter to the device during a second-time-period of the monitoring-sequence, and wherein the determining comprising measuring and calculating a decay factor by the controller.

According to another aspect of the present disclosed subject matter, a wireless power charging system having a device comprising a speaker configured to play audio-coded data-file, the system comprising: a transmitter, having a controller, wherein the controller is configured to detect voltage or current fluctuations in a coil of the transmitter resulting from external magnetic fields caused by the speaker playing the audio-coded data-file, wherein the fluctuations correspond to a plurality of different audio-tones that the audio-coded data-file is composed of, and wherein the controller is also configured decode and process the audio-tones for assembling the data-file and store the file in a memory of the controller.

In some exemplary embodiments, the transmitter further comprising a driver and an AC sensor selected from the group consisting of an AC current sensor; an AC voltage sensor; and a combination thereof.

In some exemplary embodiments, the driver is set to either tri-state or short-state when the controller is configured to the detect voltage or current fluctuations, wherein the driver is set to tri-state if an AC current sensor is used for detecting current fluctuations and wherein the driver is set to short-state if an AC voltage sensor is used for detecting voltage fluctuations.

In some exemplary embodiments, the transmitter is configured communicate to the device a communication error message.

In some exemplary embodiments, the controller is configured to determine if the device comprising a power receiver is placed on the transmitter by sending a ping and determining a decay factor resulting from the ping.

In some exemplary embodiments, the driver is configured to provide wireless power transmission to the device comprising power receiver is placed on the transmitter.

### BRIEF DESCRIPTION OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

In the drawings:

FIG. 1 shows a cross-section view of a layout of a wireless power charging system, in accordance with some exemplary embodiments of the disclosed subject matter;

FIG. 2 shows a block diagram of a wireless power charging system, in accordance with some exemplary embodiments of the disclosed subject matter; and

FIG. 3A and 3B show flowchart diagrams of a method, in accordance with some exemplary embodiments of the disclosed subject matter.

### DETAILED DESCRIPTION

Before explaining at least one embodiment of the disclosed subject matter in detail, it is to be understood that the disclosed subject matter is not limited in its application to the details of construction and the arrangement of the components set forth in the following description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

The terms “comprises”, “comprising”, “includes”, “including”, and “having” together with their conjugates mean “including but not limited to”. The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this disclosed subject matter may be presented in a range format. It should be understood that the description in range format is merely for convenience and brevity and should not be construed as an inflexible limitation on the scope of the disclosed subject matter. Accordingly, the description of a range should be considered to have specifically disclosed all the possible sub-ranges as well as individual numerical values within that range.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination or as suitable in any other described embodiment of the disclosed subject matter. Certain features described in the context of various embodiments are not to be considered essential features of those embodiments unless the embodiment is inoperative without those elements.

An objective of the present disclosure subject matter is to provide an enhanced wireless power transmitter that comprises a mechanism for receiving audio coded data files from devices having a coil-based speaker, in addition to wirelessly transmitting power to a wireless power receiver of the device.

In some exemplary embodiments, the present disclosure teaches a communication system and method for inductively coupled units, such as a transmitter and a receiver of a wireless power system, for communicating audio coded data files generated by a coil-based speaker.

Additionally, or alternatively, the present disclosure teaches a system and method for modem communication of audio-coded data-files between a wireless power transmitter and a device, having a built-in speaker, given that transmitter and the device are substantially close to each other.

In some exemplary embodiments, the present disclosure features the implementation of communication and over the air (OTA) software/firmware upgrades of a transmitter, from any device capable of playing sound via a speaker. It will be noted that enhancing the transmitter with such communication features/mechanisms involves incorporating additional software components to a controller of the transmitter.

In some exemplary embodiments, the communication is based on audio-coded data-files that comprise information, such as firmware files, configuration information files, policy updates, instructions allowing/disallowing charging.

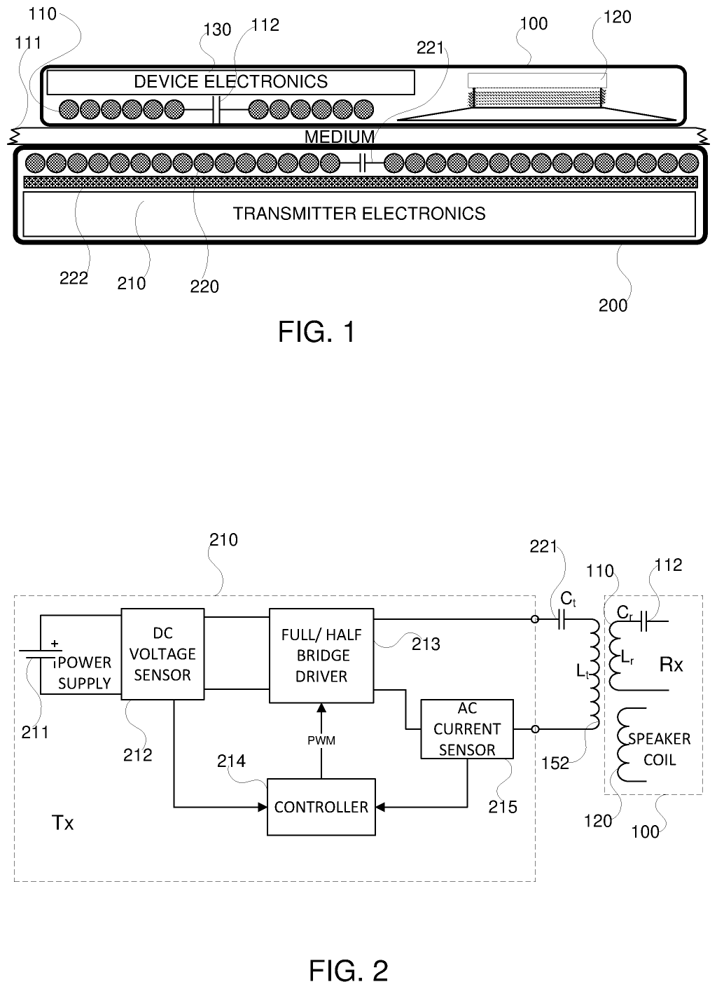

Referring now to FIG. 1 showing a cross-sectional view of a wireless power charging system, in accordance with some exemplary embodiments of the disclosed subject matter. The wireless power charging system comprises a transmitter 200 and a device 100 that may or may not be separated by a medium 111. Typically, medium 111 is surfaces, such as tables, desks, bars, or the like, made of non-conductive material, such as wood, plastic vinyl, marble, or the like. Additionally, medium 111 can be a commercially available casing for device 100 that is made of plastic, leather or any combination of nonconductive material.

In some exemplary embodiments, device 100 can be a device that comprises a built-in speaker, such as a smartphone, a tablet, a laptop PC, a mobile phone, an audio player, a media player, a combination thereof, or the like. The device 100 can be powered by a chargeable battery that is capable of being charged by wires or wirelessly by a receiver of a commercially available wireless power system. In some exemplary embodiments, the receiver of device 100 comprises a coil 110, and a resonance capacitor Cr 112, that can be inductively coupled with a transmitter coil 220, also provided with a resonance capacitor, i.e. Cr 221 of the transmitter 200.

In some exemplary embodiments of the disclosed subject matter, device 100 further comprises a controller 130 and a speaker 120 constructed of a moving coil connected to a membrane and coupled to a fixed magnetic core. In addition to its primary designation, e.g. playing music and managing phone calls, controller 130 of device 100, can but doesn't have to, control operations associated with obtaining, with its receiver, power induced by the transmitter 200.

In some exemplary embodiments, the transmitter 200 comprises a coil (Lt) 220; a ferrite 222, a resonance capacitor (Cr) 221 and transmitter electronics 210, which will be described in detail herein below. In some exemplary embodiments, Lt 220 can be a flat spiral air core coil that allows for relatively high coupling between Lt 220 and Lr 110 despite a thickness of medium 111. In some exemplary embodiments, transmitter 200 comprises a transmitter ferrite 222, which can be a layer made of ferrite material with suitable magnetic characteristics of permeability & core losses. One technical reason for utilizing the transmitter-ferrite 222 is providing a buffer for protecting transmitter-electronics 210 from inductive energy. Another technical reason for utilizing the transmitter-ferrite 222 can be to increase the magnetic field facing receiver coil 110.

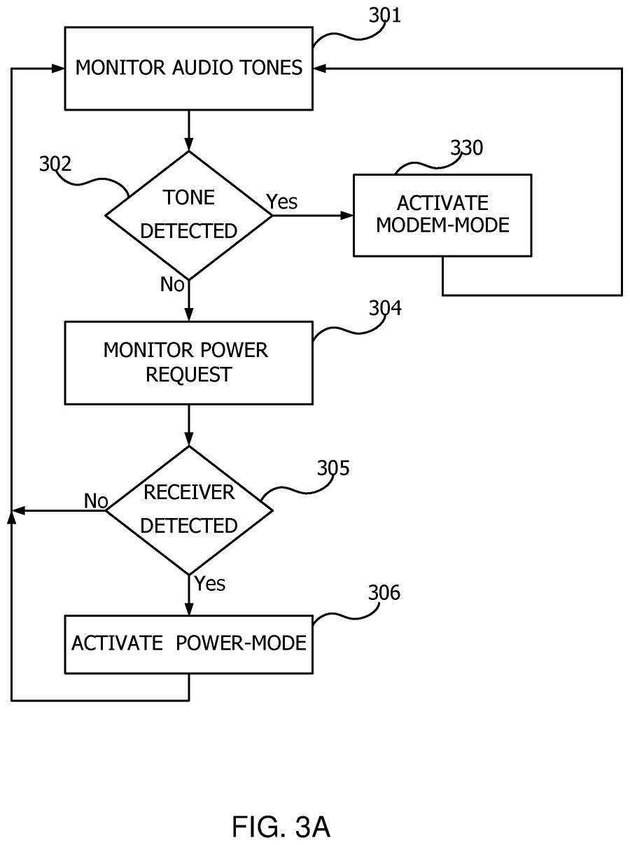

Referring now to FIG. 2 showing a block diagram of a wireless power charging system, in accordance with some exemplary embodiments of the disclosed subject matter. The wireless power charging system comprises a transmitter-electronics 210; a Lt 220; and a Ct 221, of transmitter 200, and Lr 110; Cr 112; and a speaker 120 of device 100. In some exemplary embodiments, the Lt 220 coil, and the capacitor Ct 221 of transmitter 200 are configured for inducing current to coil Lr 110 of the receiver of device 100. In some exemplary embodiments of the disclosed subject matter, transmitter 200 can be configured for (receiving) obtaining and processing audio-coded data-files originated at device 100 and played by its speaker 120.

In some exemplary embodiments, the transmitter-electronics 210 comprises a controller 214; a full and/or half-bridge driver 213, a DC voltage sensor 212 (optional), and a power supply 211 and an AC sensor 215, which can be either current sensor or voltage sensor or both.

Controller 214 can be a central processing unit (CPU), a microprocessor, an electronic circuit, an integrated circuit (IC), or the like. Additionally, or alternatively, controller 214 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). In some exemplary embodiments, controller 214 can be utilized to perform computations required by transmitter 200 or any of its subcomponents.

In some exemplary embodiments of the disclosed subject matter, the controller 214 can be configured to utilize sensors 212, or the like, for determining DC voltage across power supply 211 or DC current supplied by a power supply 211. Controller 214 can also be configured to utilize sensor 215 for determining AC current or AC voltage supplied to Lt 220. It should be noted that determining AC current parameters can comprise peak current, an average of absolute current, RMS current, the amplitude of first harmonic, and any combination thereof, or the like.

In some exemplary embodiments, the transmitter 200 comprises an indicator for communicating to the user. The indicator can be a LED having colors for different messages; a busser that can play different tones for different messages; and any combination thereof, or the like.

In some exemplary embodiments, controller 214 comprises a semiconductor memory component (not shown). The memory can be persistent or volatile memory, such for example, a flash memory, a random-access memory (RAM), a programmable read-only memory (PROM), a re-programmable memory (FLASH), and any combination thereof, or the like.

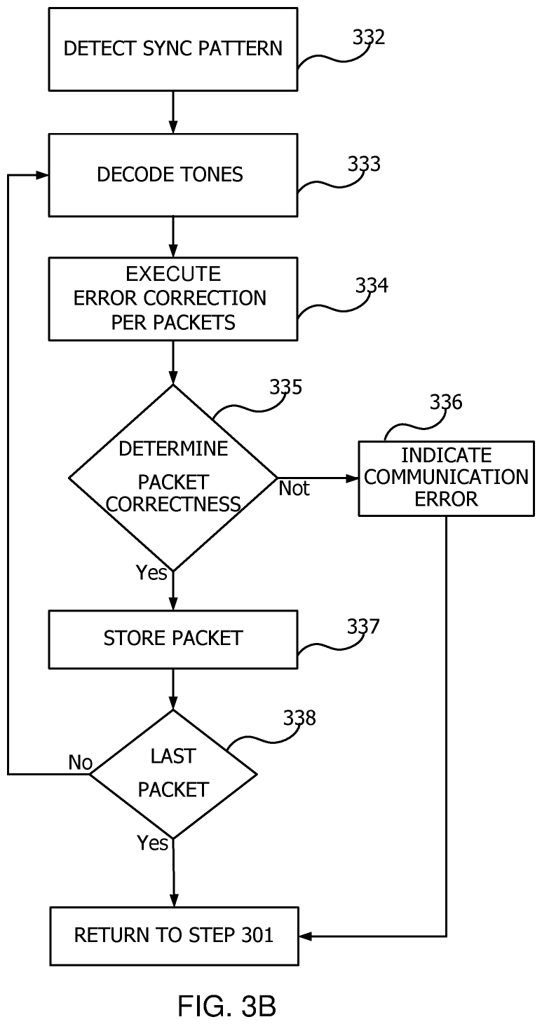

In some exemplary embodiments, the memory can be configured to retain program code to activate controller 214 to perform acts associated with determining a pulse width modulation (PWM) signal that controls the full or half-bridge driver 213. Additionally, or alternatively, the memory of controller 214 can retain instructions and code adapted to cause the controller 214 to execute methods, such as the method depicted in FIGS. 3A and 3B.

In some exemplary embodiments, driver 213 can adjust the output current flowing through Lt 220, i.e. power provided by the transmitter 100, by modulating an operational frequency and/or duty cycle and/or changing the voltage supplied to the driver of the current flowing through Lt 220. Additionally, the PWM (pulse width modulation) signal generated by the controller 214 tunes the modulation to satisfy the wireless charging needs device 100. It should be noted that the PWM signal frequency and duty cycle can be set by controller 214, within the operational frequency range. Additionally, controller 214 can change the operating frequency within the operational frequency range and/or changing the voltage supplied to the driver based on the power demand of the device 100.

In some exemplary embodiments, the controller 214 can utilize its memory to retain, connectivity software; monitoring information; configuration and control information; code of application associated with charging management; information acquired from device 100, and any combination thereof, or the like.

In some exemplary embodiments, the controller 214 of transmitter 200 can be configured to communicate with device 100 for acquiring information comprising: firmware files for updating/upgrading the controller's firmware/software, transmitter 200 configuration files; user's credentials for authentication; enable/disable charging instructions; device 100 power requirements; receiver coil 110 Q factor and any combination thereof, or the like. It will be appreciated that the information can be retained in the memory of controller 214.

In some exemplary embodiments of the disclosed subject matter, the controller 214 can set transmitter 200, and consequently, the wireless power charging systems of the present disclosure, to operate at one of the following modes of operation: power transfer (power) mode; monitoring-mode; and data-files communication (modem) mode.

It should be noted that in power mode, driver 213 can drive AC current for creating necessary magnetic flux, in the transmitter's resonant circuit, for charging the device. It should also be noted that devices having inductive receivers can exercise load modulation capability for sending information to the transmitter. The load modulation can be accomplished by toggling a load element at the receiver end, consequently creates voltage fluctuation at the resonant circuit of the transmitter. In some exemplary embodiments, controller 214 is provided with a sensing circuit configured for sensing voltage fluctuation resulting, which can result from: load modulation; external magnetic fields a combination thereof, or the like.

In some exemplary embodiments, the wireless power charging system of the present disclosure can exploit such modulation capability, for sending information from the device to the transmitter, with external magnetic fields, such as speaker 120.

It should be noted that speaker 120 is comprised of a moving coil coupled to a fixed magnetic core and coupled to a membrane. Current flowing through the coil causes the coil and coupled membrane to move and create oscillations in the air i.e. sound. Simultaneously, the alternating current flowing through the speaker also generates alternating magnetic flux via its coil, consequently producing voltage fluctuation on the resonant circuit of transmitter 200 (external magnetic fields), which can be sensed by the sensing circuit of controller 214.

Therefore, when a speaker is placed in substantially close proximity to the transmitter coil, voltage shall be induced on the transmitter coil, and the controller can sense voltage fluctuation, resulting from current induced by the alternating flux created by the speaker while playing sound.

In some exemplary embodiments, the device comprises one or more digital sound-files, retained in a memory (not shown) of controller 130 that is configured to be played on its speaker. The sound-files can be coded using standard audio formats, such as WAV, MP3, or the like. Controller 130 further comprises a driver (not shown) for driving current to the coil 120 of the speaker where the current varies according to the content of a digital sound-file. In some exemplary embodiments, the sound played by the speaker can comprise multiple characteristic tones, which are intended to be individually detected by the transmitter's controller 214.

In some exemplary embodiments, the characteristic tones can be, for example, sine signals having specific frequencies within the audio band supported by the speaker, typically in the range of 500 Hz to 15 KHz, for small size speakers. In some exemplary embodiments, data bits can be coded to specific tones or tone combinations that allow effective modem transmission from a digital sound-file on device 100 to the transmitter 200.

In some exemplary embodiments, the sound file information can be encoded to the played modem tones. The encoding can also comprise error corrections for mitigating errors in decoding on the transmitter side. For example, each N bits of data, additional M bits are added to form a word that enables correction of errors in reception. Additionally, or alternatively Reed-Solomon error correction codes can be used for that purpose. In some exemplary embodiments, the digital sound-file can comprise a predetermined (fixed) set of tones at its header (beginning of the file), which can be used by the controller 214 to synchronize and detect a start of transmission.

Monitoring-mode is governed by a predetermine monitoring-sequence, comprised of X-milliseconds of detection of a device having power receiver and Y-milliseconds of detection of digital audio-file transmission. In some exemplary embodiments, an analog ping may be used for detection of placement of devices having power receivers, on the transmitter, is interleaved with sound-file transmission detection. The monitoring-sequence is determined to ensure that its duration is longer than the duration of an analog ping session, to ensure that the transmitter would not miss the start of the sound-file transmission.

In some exemplary embodiments, the controller 214 sets driver 213 to either tri-state or short-state during the predetermine monitoring-sequence while transmitter 200 monitor digital audio-file transmission. It should be noted that the drivers are set to either tri-state if the transmitter employs voltage sensing for the detection or short-state if the transmitter employs current sensing for the detection. Alternatively, the drivers are set to short-state, if the transmitter employs current sensing, by setting the PWM signal to either “logic zero” GND or “logic one” (VCC). Thereby, a change in external magnetic flux creates induced voltage or current (depending on the state) on the transmitter's resonant circuit that can be sensed by the controller.

Also, in data-files communication mode, the controller 214 sets the driver 213 to either tri-state or short-state to cease power transfer activity, during which the controller sense voltage/current fluctuation on the resonant circuit and analyzes them for detecting specific audio tones that are used for communication.

While the transmitter 200 is in monitoring-mode, i.e. not performing wireless power transfer and not detecting data-files, the controller 214 monitors the transmitter's resonance circuit. In some exemplary embodiments, upon detecting specific modem tone/tones, the controller switches to data-files communication mode and starts decoding the transmitted modem signals to extract the coded data until the communication is completed. Additionally, or alternatively, if while in monitoring-mode, the controller 214 determines that a device having a power receiver, was placed on the transmitter, the controller switches to power mode until power transfer is completed or the device is removed.

It will be noted that the solutions/procedures/methods described in the present disclosure are not limited to the system depicted in FIGS. 1 and 2 of the present disclosure, and in fact, can apply to enhance the operation and communication of commercially available inductive power transfer systems. The description of the embodiments hereinafter refers to elements of the system depicted in FIGS. 1 and 2 that are used as examples for describing the following solutions/procedures that may apply to other wireless power charging systems.

The components detailed above can be implemented as one or more sets of interrelated computer instructions, executed for example by controller 214 or by another processor for communicating the information between device 100 and transmitter 200. The components can be arranged as one or more executable files, dynamic libraries, static libraries, methods, functions, services, or the like.

Referring now to FIGS. 3A and 3B showing flowchart diagrams of a method, in accordance with some exemplary embodiments of the disclosed subject matter. The method is used for a modem communication of audio-coded data-files between a wireless power transmitter and a device, having a built-in speaker. In some exemplary embodiments, data bits of the data-files can be coded to specific tones or tone combinations that allow effective modem transmission of a digital sound-file stored in device 100 to the transmitter 200.

It should be noted that the audio coding/decoding concept described in this present disclosure is just one exemplary embodiment of coding the data files. The system of the present disclosure can be configured to utilize known in the art audio-based encoding/decoding for modem communication. In some exemplary embodiments, the modem communication of the present disclosure can be initiated by a user activating a play function of the device while the device is placed on the transmitter. In some exemplary embodiments, the user uses device 100 as a tool for transmitting information to the transmitter. The information can comprise firmware updating/upgrading; configuration files; user's credentials for authentication; enable/disable charging instructions; power requirements; receiver's Q factor; and any combination thereof, or the like.

In step 301, audio tones is monitored. In some exemplary embodiments, controller 214 can be used to sense/monitor coil 152 for voltage/current fluctuations, indicative of audio tones, for a duration of Y-milliseconds of the monitoring sequence of the monitoring-mode, where [Y] ranges (for example) between 10 to 100 milliseconds. It will be reminded that the controller 214 sets driver 213 to either tri-state or short-state during audio tones monitoring.

In step 302, a tone is to be detected. In some exemplary embodiments, the tone is manifested as the voltage/current of the coil fluctuation. It should be noted that the voltage/current of the coil is monitored, by the controller 214 at a rate that is at least twice the rate of highest tone, thus if the highest tone voltage/current fluctuate at 10 KHz then the sampling rate of the controller must be at least 20 khz.

In one exemplary embodiment, the audio-coding can comprise two tones, for example, a 1 KHz tone for encoding “0” and 2 KHz tone for encoding “1”. In another exemplary embodiment, the audio-coding comprises 16 tones that ranges for example from 500 Hz to 8 KHz in increments of 500 Hz. Thereby, each tone provides 4 bits (i.e. first tones of 500 Hz codes for 0000, second tones of 1 KHz codes for 0001 . . . first tones6 of 8 KHz codes for 1111. In some exemplary embodiments, detection of digital audio-file transmission (modem communication) is determined when the sensor of controller 214 detects a correlation to a specific tone pattern used for synchronization was performed.

In step 330, a modem-mode is activated. In some exemplary embodiments, the controller 214 activates modem-mode comprising executing an audio-coded data-file reception sequence following a determination of modem communication in step 302. It will be reminded that the controller 214 sets driver 213 to either tri-state or short-state while modem-mode is activated.

In step 304, a power request is monitored. In some exemplary embodiments, following an absence of modem communication determination of step 302, the controller activates the driver to send a standard wireless power analog ping sequence for determining a presence of a device having a power receiver. In some exemplary embodiments, controller 214 initiates the analog ping for the duration of X-milliseconds of the monitoring-mode, where [X] ranges (for example) between 2 to 10 milliseconds. In some exemplary embodiments, the analog ping comprises a plurality of short pulses of approximately 1 microsecond each.

It should be noted that the monitoring sequence of the monitoring-mode is comprised of the X duration alternating with the Y duration, wherein the monitoring sequence repeats itself as long no modem communication or power request was detected.

In step 305, a device having a power receiver is detected. It will be appreciated that a detection of a device having a power receiver is treated by the controller 214 as a power request for the transmitter to charge the device. In some exemplary embodiments, following the ping sequence of step 304, the controller 214 monitors the voltage/current of coil 152 by measuring its decay rate or its amplitude or a combination thereof for determining a decay factor of the ping. In some exemplary embodiments, a decay factor that exceeds a predetermined threshold is indicative of a presence of a device having receiver coil, i.e. power request. Alternatively, if the decay factor is below the predetermined threshold, the controller shall repeat the monitoring sequence starting with monitoring audio tones.

In step 306, a power-mode is activated. In some exemplary embodiments, the controller 214 shall invoke standard wireless power transmission to device 100 until the receiver sends an end of power message or until communication with the receiver is lost due to its removal.

In some exemplary embodiments of the disclosed subject matter, the data-file played by the device can be encoded and composed as described hereinafter. Each data-file may be preceded by a sync pattern comprising specific sync tones, for example, first-tones and second-tones that alternate during 100 milliseconds. In some exemplary embodiments, binary “0” and binary “1” values of each packet of the data-file are coded using third-tones and forth-tones respectively.

In some exemplary embodiments, the data file is made of packets each comprising 192 bytes plus 24 (Reed Solomon) error correction bytes totaling 216 bytes, wherein each packet comprises a preamble of 24 bits of zeros and ones that indicates the packet beginning. Additionally, or alternatively, the first packet of the data file comprises an 8 bytes header, wherein the first 4 bytes define the file length and the following 4 bytes are the checksum of the entire file. In some exemplary embodiments, the last packet is padded with zeros for indicating the end of the file.

In step 332, a sync pattern is identified. In some exemplary embodiments, controller 214 determines the sync pattern by detecting a string of first-tones and second-tones, thereby indicating upcoming packets that make the data-file.

In step 333, tones are decoded. In some exemplary embodiments, controller 214 detects the third-tones and forth-tons, of each packet of a plurality of packets of the data file and converts them to bits, followed by processing the bits to packets. In some exemplary embodiments, controller 214 is also configured to extracting a plurality of Reed Solomon error correction bytes from each packet.

In step 334, an error correction per packets is executed. In some exemplary embodiments, controller 214 utilizes the plurality bytes of the Reed Solomon error correction to correct the packet.

In step 335, packet correctness is determined. In some exemplary embodiments, controller 214 determines if the packet is correct.

In step 336, a communication error is indicated. In some exemplary embodiments, the controller resets driver 213 to exit the tri-state or the short-state and send the device a message, using alternative communications methods, such as PMA; WPC; and AirFuel, which will indicate to the user of a communication error. Additionally, or alternatively, the controller activates the indicator of the transmitter 200, for flagging the communication error to the user.

Following the message controller 214 switch the transmitter back to monitoring mode starting at step 301.

In step 337, the packet is stored. In some exemplary embodiments, if the packet was correct, the controller stores the packet to its memory to form the data file.

In step 338, the last packet is determined. In some exemplary embodiments, the controller determines if the packet was the last packet of the data file by comparing an index number of the packet with the value of the 4 bytes that define the file length or check the amount of the packet padded zeros. In some exemplary embodiments, upon determining the last packet the controller assembles the packets into a data file and stores the file in the memory of the controller.

In some exemplary embodiments, if the packet was not the last one, the controller repeats the process by returning to step 333. If the packet was the last the controller uses the 4 bytes of checksum for determining the correctness of the entire file and switch back to monitoring mode starting at step 301, providing that the checksum checked okay, else the controller goes to step 336.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A communication method for wireless power charging system having a device comprising a speaker that is configured to play audio-coded data-file, the method comprising:
detecting, by a controller of a transmitter, voltage or current fluctuations in a coil of the transmitter;
executing an audio-coded data-file reception-sequence;
determining if the device comprising a power receiver; and
activating wireless power transmission to the device,
wherein the fluctuations correspond to audio-tones composing the audio-coded data-file played by the speaker, and wherein the reception-sequence decode and
process the audio-tones for assembling the data-file.

2. The method of claim 1, wherein the detecting comprising decoding fluctuations corresponding to a plurality of different audio-tones generated by the device for encoding information of the data-file, and wherein the fluctuations in the coil results from external magnetic fields caused by audio-tones played by speaker.

3. The method of claim 2, wherein the detecting is conducted during a first-time-period of a monitoring-sequence, wherein the transmitter is set to either tri-state or short-state in the first-time-period.

4. The method of claim 3, wherein the first-time-period is at least two times longer than a time period of any audio-tone of the audio-tones.

5. The method of claim 2, wherein the audio-tones comprising sixteen different tones, and wherein each tone of the sixteen different tones corresponding to four bits of data.

6. The method of claim 2, wherein the executing comprising identifying a sync pattern preceding the data-file, wherein the sync pattern is composed of a string of audio-tones selected from the group consisting of first-tones; and second-tones.

7. The method of claim 2, wherein the executing comprising converting the audio-tones to binary bits, wherein the audio-tones are selected from the group consisting of third-tones; and fourth-tones, wherein of the third-tones are converted to ones and fourth-tones are converted to zeros, and wherein the executing further comprising processing the bits to packets and extracting a plurality of error correction bytes from each packet.

8. The method of claim 2, wherein the executing comprising utilizing the plurality of error correction bytes for executing error correction for each packet.

9. The method of claim 2, wherein the executing comprising extracting from each packet a preamble indicating a beginning of the packet and extracting a value defining a length of the data-file and a checksum value of the file from a first packet of the data-file.

10. The method of claim 8, wherein the executing further comprising indicating a communication error to the device that results from a failure of said executing error correction.

11. The method of claim 2, wherein the executing comprising determining a last packet and assembling the packets into a date file and storing the file in a memory of the controller.

12. The method of claim 3, wherein said determining if the device comprising a power receiver further comprising determining if the device comprising a power receiver is placed on the transmitter by sending a ping from the transmitter to the device during a second-time-period of the monitoring-sequence, and wherein the determining comprising measuring and calculating a decay factor by the controller.

13. A transmitter of a wireless power charging system having a device comprising a speaker configured to play audio-coded data-file, the system comprising: a transmitter, having a controller, wherein the controller is configured to detect voltage or current fluctuations in a coil of the transmitter resulting from external magnetic fields caused by the speaker playing the audio-coded data-file, wherein the fluctuations correspond to a plurality of different audio-tones that the audio-coded data-file is composed of, and wherein the controller is also configured decode and process the audio-tones for assembling the data-file and store the file in a memory of the controller.

14. The transmitter of claim 13, wherein the transmitter further comprising a driver and an AC sensor selected from the group consisting of an AC current sensor; an AC voltage sensor; and a combination thereof.

15. The transmitter of claim 14, wherein the driver is set to either tri-state or short-state when the controller uses an AC voltage sensor for detecting voltage fluctuations, and wherein the driver is set to short-state when the controller uses an AC current sensor for detecting current fluctuations.

16. The transmitter of claim 14, wherein the transmitter is configured to activate a communication error indicator.

17. The transmitter of claim 14, wherein the controller is configured to determine if the device comprising a power receiver is placed on the transmitter by sending a ping and determining a decay factor resulting from the ping.

18. The transmitter of claim 17, wherein the driver is configured to provide wireless power transmission to the device comprising power receiver is placed on the transmitter.

19. The method of claim 9, wherein the executing further comprising indicating a communication error to the device that results from a failure determined based on calculating the checksum value.
